(19) United States
(12) Patent Application Publication
(10) Pub. No.: US 2025/0338306 A1
(43) Pub. Date: Oct. 30, 2025

(54) ADJUSTING LINK PRIORITY FOR MULTI-LINK DEVICES

(71) Applicant: HEWLETT PACKARD ENTERPRISE DEVELOPMENT LP, Spring, TX (US)

(72) Inventors: JIANPO HAN, Beijing (CN); Andre Beaudin, St. Laurent (CA); Omar El Ferkouss, St. Laurent (CA)

(21) Appl. No.: 18/646,355

(22) Filed: Apr. 25, 2024

(51) Int. Cl. H04W 74/00; H04W 76/15

(52) U.S. Cl. CPC H04W 74/002; H04W 76/15

(57) ABSTRACT

Examples of the presently disclosed technology provide systems and methods for adjusting link priority for multi-link devices. An example method may comprise: (1) mapping a traffic identifier (TID) to a first access category queue of a primary link; (2) mapping the TID to a second access category queue of a secondary link, wherein a contention window-related parameter for the first access category queue defines a shorter time interval than a contention window-related parameter for the second access category queue; and (3) transmitting frames according to the mappings for the TID.

### BACKGROUND

Multi-link Operation (MLO) enables devices (sometimes referred to as multi-link devices) to send and receive data across links on different frequency bands. Connecting across multiple frequency bands can increase throughput, reduce latency, improve reliability, etc.

Enhanced Multi-Link Single-Radio (eMLSR) is a type of MLO that enables a single-radio multi-link device to switch between links on different frequency bands (e.g., a 2.4 GHz link and a 5 GHz link) to improve throughput and latency.

Enhanced distributed channel access (EDCA) is a Quality of Service (QOS) mechanism in 802.11e where relatively higher priority traffic has a higher chance of being transmitted than relatively lower priority traffic. To facilitate this outcome, EDCA assigns frames/packets to access categories corresponding to levels of priority. Such access categories may include, in order of increasing priority: Background (BK or AC_BK); Best Effort (BE or AC_BE); Video (VI or AC_VI); and Voice (VO) (AC_VO). Each access category defines different time intervals for contention window-related parameters such as arbitration inter-frame space (AIFs) and contention window (CW). An access category's unique time intervals for contention window-related parameters are sometimes referred to the access category's EDCA parameters. To ensure that relatively higher priority traffic has a higher chance of being transmitted than relatively lower priority traffic, contention window-related parameters for the higher priority access categories generally define shorter time intervals than corresponding contention window-related parameters for relatively lower priority access categories. With these shorter time intervals, the relatively higher priority traffic is more likely to win contention than the relatively lower priority traffic.

A traffic identifier (TID) may refer to an identifier for classifying frames/packets based on priority. TIDs are sometimes represented as numbers from 0 to 7, where higher numbers generally correlate with higher priority.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example network deployment within which various examples of the presently disclosed technology may be implemented.

FIG. 2 depicts an example multi-link device, in accordance with various examples of the presently disclosed technology.

FIG. 3 depicts another example multi-link device, in accordance with various examples of the presently disclosed technology.

FIG. 4 depicts an example diagram illustrating contention window-related parameters for a primary link and a secondary link, in accordance with various examples of the presently disclosed technology.

FIG. 5 depicts a computing system that adjusts link priority for a multi-link device, in accordance with various examples of the presently disclosed technology.

FIG. 6 depicts another computing system that adjusts link priority for a multi-link device, in accordance with various examples of the presently disclosed technology.

FIG. 7 depicts a block diagram of an example computer system in which various of the examples described herein may be implemented.

The figures are not exhaustive and do not limit the present disclosure to the precise form disclosed.

### DETAILED DESCRIPTION

eMLSR technologies generally rely on TID-to-link mapping to assign frame traffic across multiple links. TID-to-link mapping involves mapping respective TIDs to links. For example, a default TID-to-link mapping scheme may map TIDs from 0-2 to all links, TIDs from 3-5 only to 5 GHz links, and TIDs from 6-7 only to 2.4 GHz links. Frame traffic can then be transmitted according to this default TID-to-link mapping scheme.

Multi-link devices can utilize such a default TID-to-link mapping scheme, or negotiate TID-to-link mapping schemes with other multi-link devices.

Intelligent TID-to-link mapping can be used to separate high-volume, latency-tolerant traffic flow from latency-sensitive traffic flow. However, TID-to-link mapping (whether default or negotiated) is not well-suited for adapting to changing channel conditions. In other words, TID-to-link mapping generally prescribes a static set of rules which are not adjusted in response to transient channel conditions. Accordingly, a TID-to-link mapping scheme may inflexibly prescribe a mapping to a temporarily unavailable link, or otherwise prescribe sub-optimal mappings during transient channel conditions.

Examples of the presently disclosed technology provide an improved alternative to TID-to-link mapping that better adapts to changing channel conditions. Namely, examples dynamically monitor/estimate channel quality for multiple links of a multi-link device. Examples can designate the link with the highest estimated channel as a primary link, and designate links with relatively lower estimated channel quality as secondary links. Examples can change these designations in response to changing channel conditions.

Moreover, through asymmetric TID-to-access category queue mapping, examples can ensure that frame traffic is more likely to be transmitted over the primary (i.e., higher performing) link during normal channel conditions, while still allowing frame traffic to be transmitted over the secondary links when the primary link is unavailable (e.g., due to high traffic load, interference, chip reset, scanning, etc.). Namely, examples map a respective TID to a first access category queue (e.g., a BE access category queue) of the primary link, and a second access category queue (e.g., a BK access category queue) of the secondary links, wherein one or more contention window-related parameters (e.g., AIFS, CW, etc.) for the first access category queue define shorter time intervals than corresponding contention window-related parameters (e.g., AIFS, CW, etc.) for the second access category queue. Under normal channel conditions, the primary link will be more likely to win contentions for the respective TID than the secondary link due to the shorter contention window-related time interval(s). In other words, examples can effectively “stack the deck” in favor of the primary link winning contentions over the secondary links through this asymmetric TID-to-access category queue mapping. Accordingly, during normal channel conditions most frame traffic will be transmitted over the primary link which has higher channel quality. However, if the primary link becomes temporarily unavailable (e.g., due to high traffic load, interference, chip reset, scanning, etc.), one of the secondary links may win contention for the respective TID despite its longer contention window-related time interval(s), and frame traffic may be transmitted temporarily over the secondary link.

The presently disclosed asymmetric TID-to-access category queue mapping may improve upon a conventional TID-to-link mapping scheme that maps a respective TID to the same access category queue (e.g., a VO queue) of multiple links. In other words, such conventional/“symmetric” mapping-which does not “stack the deck” in favor of a higher performing link winning contention—may send more frame traffic than desirable over a lower performing link. This is because under the conventional/“symmetric” mapping, the access category queue of the lower performing link will have the same contention window-related time interval(s) as the higher performing link, increasing the likelihood that the lower performing link wins contention over the higher performing link.

Examples of the presently disclosed technology are described in greater detail in conjunction with the following FIGS.

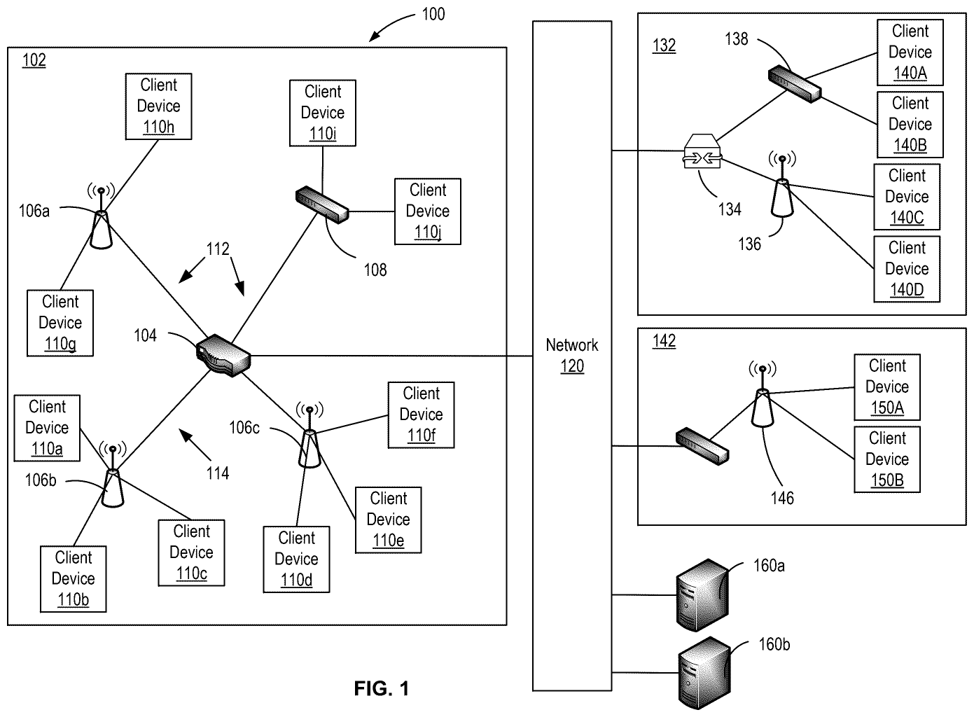

Before describing examples of the presently disclosed technology in detail, it is useful to describe an example network installation within which examples might be implemented. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network (e.g., a WLAN deployment), which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site 102 may include multiple controllers and/or multiple communication points with network 120. In some examples, the controller 104 communicates with the network 120 through a router (not illustrated). In other examples, the controller 104 provides router functionality to the devices in the primary site 102.

The controller 104 may be operable to configure and manage network devices, such as at the primary site 102, and may also manage network devices at the remote sites 132, 142. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IoT) devices, and the like. Client devices may also be referred to as stations (STA).

Within the primary site 102, a switch 108 is included as one example of a point of access to the network established in primary site 102 for wired client devices 110 i-j. Client devices 110 i-j may connect to the switch 108 and through the switch 108, may be able to access other devices within the network configuration 100. The client devices 110 i-j may also be able to access the network 120, through the switch 108. The client devices 110 i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in primary site 102 for client devices 110a-h. The APs 106a-c may control network access of the client devices 110a-h and may authenticate the client devices 110a-h for connecting to the APs and through the APs, to other devices within the network configuration 100. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 provide connectivity to the network for various client devices 140a-d.

In various examples, the remote site 132 may be in direct communication with the primary site 102, such that client devices 140a-d at the remote site 132 access the network resources at the primary site 102 as if these the clients devices 140a-d were located at the primary site 102. In such examples, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various examples, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at the remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a-j, 140a-d, 150a-b may request and access the multimedia content provided by the content servers 160a-b.

In various implementations the devices depicted in FIG. 1 may comprise multi-link devices and/or single-radio multi-link devices. As described above, MLO enables multi-link devices to send and receive data across links on different frequency bands. Connecting across multiple frequency bands can increase throughput, reduce latency, improve reliability, etc. eMLSR is a type of MLO that enables a single-radio multi-link device to switch between links on different frequency bands (e.g., a 2.4 GHz link and a 5 GHz link) to improve throughput and latency. As alluded to above (and as described in greater detail below), examples of the presently disclosed technology provide improved systems and methods for adjusting link priority for multi-link devices.

For example (and as described in greater detail below), client device 110a and AP 106b may connect (or may be enabled to connect) with each other over a 5 GHz link and a 2.4 GHz link. Client device 110a and/or AP 106b can dynamically monitor/estimate channel quality for the 5 GHz link and the 2.4 GHz. Client device 110a and/or AP 106b can designate the link with the highest estimated channel as a primary link (e.g., the 5 GHz link), and designate the link with relatively lower estimated channel quality as a secondary link (e.g., the 2.4 GHz link). Client device 110a and/or AP 106b can change these designations in response to changing channel conditions. Client device 110a and/or AP 106b can use various techniques to make these dynamic estimations, such as techniques that analyze channel width, channel busy level, physical rate, interference level, signal strength (in some examples, represented by a received signal strength indicator (RSSI)) exhibited on a link, transmission or reception failures, etc. For example, client device 110a and/or AP 106b can estimate link quality using the following equation

For example, client device 110a and/or AP 106b can estimate link quality using the following equation:

$$LINK\_QUAL = {CHAN\_BW}^{*} {( 1 - CHANNEL\_UTILIZATION )}^{*} 100 {\%}^{*} {PHY\_RATE}^{*} ( 1 - RETRY\_RATIO )$$

Here, “LINK_QUAL” may represent link quality for a link. “CHAN_BW” may represent channel bandwidth for the link. “CHANNEL_UTILIZATION” may represent channel utilization for the link. “PHY_RATE” may represent physical rate for the link. “RETRY_RATIO” may represent retry ratio for the link.

Moreover, through asymmetric TID-to-access category queue mapping, client device 110 can ensure that frame traffic is more likely to be transmitted over the primary (i.e., higher performing) link during normal channel conditions, while still allowing frame traffic to be transmitted over the secondary link when the primary link is unavailable (e.g., due to high traffic load, interference, chip reset, scanning, etc.).

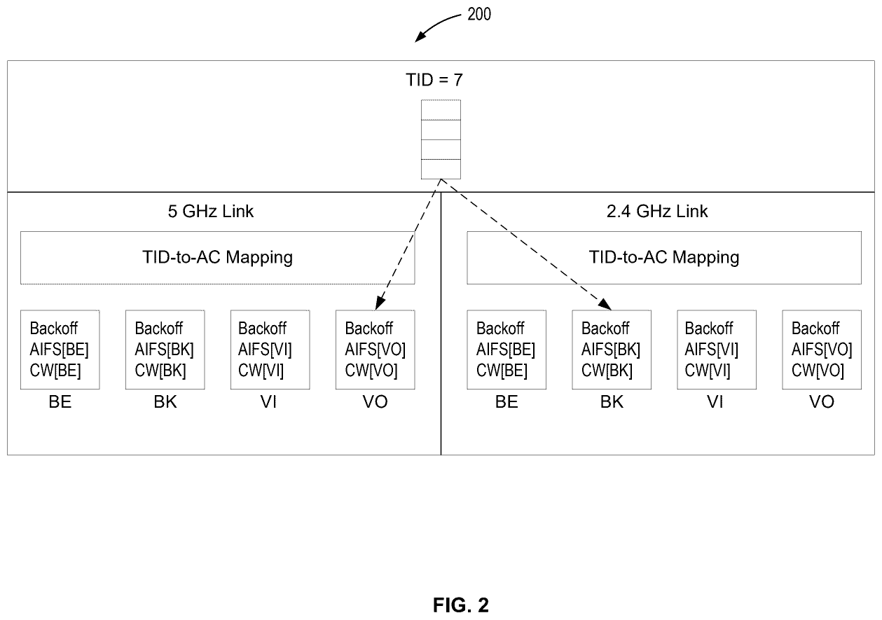

FIG. 2 depicts an example multi-link device 200, in accordance with various examples of the presently disclosed technology.

As depicted, multi-link device 200 may utilize MLO to send and receive data across links on different frequency bands. In the specific implementation of FIG. 2, multi-link device 200 can send/receive data across a 5 GHz link and/or a 2.4 GHz link. However, in other implementations multi-link device 200 may be able to send/receive data across additional links and/or across links of different frequency bands (e.g., a 6 GHz link, 7 GHz link, etc.).

In certain implementations, multi-link device 200 may comprise a single-radio multi-link device. In such implementations, multi-link device 200 can utilize eMLSR to switch between the 2.4 GHz link and the 5 GHz link to improve throughput and latency.

As described above, eMLSR technologies generally rely on TID-to-link mapping to assign frame traffic across multiple links. TID-to-link mapping involves mapping respective TIDs to links. For example, a default TID-to-link mapping scheme may map TIDs from 0-2 to all links, TIDs from 3-5 only to 5 GHz links, and TIDs from 6-7 only to 2.4 GHz links. Frame traffic can then be transmitted according to this default TID-to-link mapping scheme.

Multi-link devices (e.g., multi-link device 200) can utilize such a default TID-to-link mapping scheme, or negotiate TID-to-link mapping schemes with other multi-link devices.

Intelligent TID-to-link mapping can be used to separate high-volume, latency-tolerant traffic flow from latency-sensitive traffic flow. However, TID-to-link mapping (whether default or negotiated) is not well-suited for adapting to changing channel conditions. In other words, TID-to-link mapping generally prescribes a static set of rules which are not adjusted in response to transient channel conditions. Accordingly, a TID-to-link mapping scheme may inflexibly prescribe a mapping to a temporarily unavailable link, or otherwise prescribe sub-optimal mappings during transient channel conditions.

As described above, examples of the presently disclosed technology provide an improved alternative to TID-to-link mapping that better adapts to changing channel conditions. For instance, multi-link device 200 can dynamically monitor/estimate channel quality for its 5 GHz link and its 2.4 GHz. Multi-link device 200 can designate the link with the highest estimated channel as a primary link (e.g., the 5 GHz link), and designate the link with relatively lower estimated channel quality as a secondary link (e.g., the 2.4 GHz link). Multi-link device 200 can change these designations in response to changing channel conditions. Multi-link device 200 can use various techniques to make these dynamic estimations, such as techniques that analyze channel width, channel busy level, physical rate, interference level, signal strength (in some examples, represented by a received signal strength indicator (RSSI)) exhibited on a link, transmission or reception failures, etc. For example, Multi-link device 200 can estimate link quality using the following equation:

$$LINK\_QUAL = {CHAN\_BW}^{*} {( 1 - CHANNEL\_UTILIZATION )}^{*} 100 {\%}^{*} {PHY\_RATE}^{*} ( 1 - RETRY\_RATIO )$$

Here, “LINK_QUAL” may represent link quality for a respective link. “CHAN_BW” may represent channel bandwidth for the respective link. “CHANNEL_UTILIZATION” may represent channel utilization for the respective link. “PHY_RATE” may represent physical rate for the respective link. “RETRY_RATIO” may represent retry ratio for the respective link.

Moreover, through asymmetric TID-to-access category queue mapping, multi-link device 200 can ensure that frame traffic is more likely to be transmitted over the primary (i.e., higher performing) link during normal channel conditions, while still allowing frame traffic to be transmitted over the secondary link when the primary link is unavailable (e.g., due to high traffic load, interference, chip reset, scanning, etc.).

For instance, in response to current channel conditions, multi-link device 200 may estimate that its 5 GHz link has a higher channel quality than its 2.4 GHz link. Accordingly, multi-link device 200 can designate the 5 GHz link as the primary link, and the 2.4 GHz link as the secondary link.

Muti-link device 200 can then map a respective TID to a first access category queue of the 5 GHz (i.e., primary) link. Relatedly, multi-link device 200 can map the respective TID to a second access category queue of the 2.4 GHz (i.e., secondary) link, wherein one or more contention window-related parameters (e.g., AIFS, CW, etc.) for the first access category queue define shorter time intervals than corresponding contention window-related parameters for the second access category queue.

For instance (and as depicted), multi-link device 200 can map a TID of 7 to a Voice/VO access category queue of the 5 GHZ (i.e., primary) link. Relatedly, multi-link device 200 can map the TID of 7 to a Background/BK access category queue of the 2.4 GHz (i.e., secondary) link. In general, the Voice/VO access category defines shorter time intervals for contention window-related parameters—e.g., AIFS and CW—than the Background/BK access category. Thus, under normal channel conditions, the 5 GHz (i.e., primary) link will be more likely to win contentions for the TID of 7 than the 2.4 GHz (i.e., secondary) link due to these shorter contention window-related time intervals. In other words, multi-link device 200 can effectively “stack the deck” in favor of the 5 GHz (i.e., primary) link winning contentions over the 2.4 GHz (i.e., secondary link) through this asymmetric TID-to-access category queue mapping. While not depicted, multi-link device 200 can map other TIDs in the same/similar manner as the TID of 7.

Accordingly, during normal channel conditions most frame traffic will be transmitted over the 5 GHZ (i.e., primary) link which has higher channel quality. However, if the 5 GHZ (i.e., primary) link becomes temporarily unavailable (e.g., due to high traffic load, interference, chip reset, scanning, etc.), the 2.4 GHZ (i.e., secondary) link may win contention for a respective TID despite its longer contention window-related time intervals, and frame traffic may be transmitted temporarily over the 2.4 GHZ (i.e., secondary) link.

The presently disclosed asymmetric TID-to-access category queue mapping may improve upon a conventional TID-to-link mapping scheme that maps a respective TID to the same access category queue (e.g., a VO access category queue) of multiple links. In other words, such conventional/“symmetric” mapping-which does not “stack the deck” in favor of a higher performing link winning contention—may send more frame traffic than desirable over a lower performing link. This is because under the conventional/“symmetric” mapping, the access category queue of the lower performing link will have the same contention window-related time intervals as the higher performing link, increasing the likelihood that the lower performing link wins contention over the higher performing link.

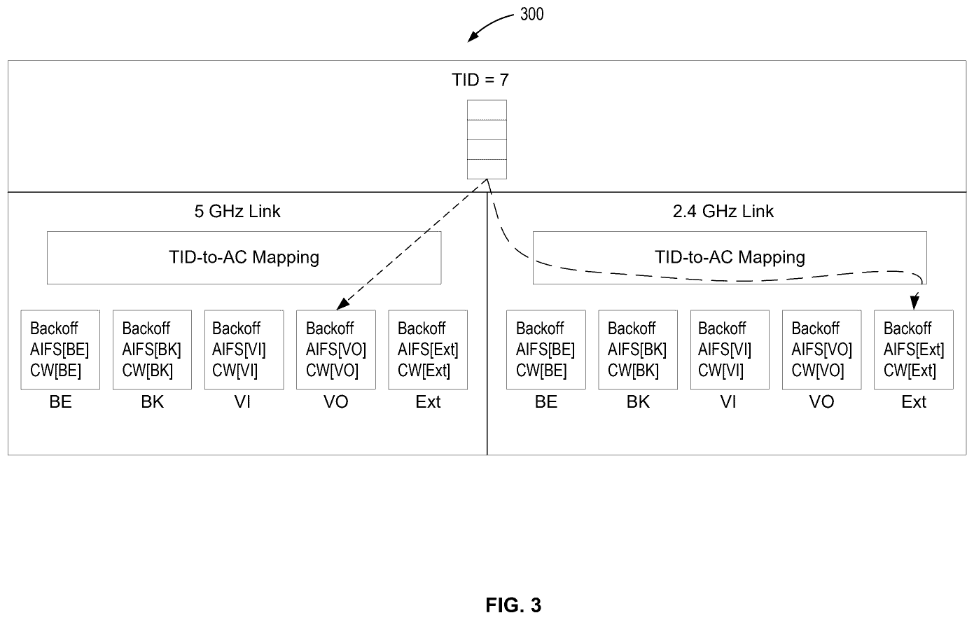

FIG. 3 depicts an example multi-link device 300, in accordance with various examples of the presently disclosed technology.

Like multi-link device 200 from FIG. 2, multi-link device 300 may utilize MLO to send and receive data across links on different frequency bands. In the specific implementation of FIG. 3, multi-link device 300 can send/receive data across a 5 GHz link and/or a 2.4 GHz link. However, in other implementations multi-link device 300 may be able to send/receive data across additional links and/or across links of different frequency bands (e.g., a 6 GHz link, 7 GHz link, etc.).

Like multi-link device 200 from FIG. 2, in certain implementations multi-link device 300 may comprise a single-radio multi-link device. In such implementations, multi-link device 300 can utilize eMLSR to switch between the 2.4 GHz link and the 5 GHz link to improve throughput and latency.

Like multi-link device 200 from FIG. 2, multi-link device 300 can utilize asymmetric TID-to-access category queue mapping to ensure that frame traffic is more likely to be transmitted over a primary (i.e., higher performing) link during normal channel conditions, while still allowing frame traffic to be transmitted over a secondary link when the primary link is unavailable (e.g., due to high traffic load, interference, chip reset, scanning, etc.).

For instance, in response to current channel conditions, multi-link device 300 may estimate that its 5 GHz link has a higher channel quality than its 2.4 GHz link. Accordingly, multi-link device 300 can designate the 5 GHz link as the primary link, and the 2.4 GHz link as the secondary link.

Multi-link device 300 can then map a respective TID to a first access category queue of the 5 GHZ (i.e., primary) link. Relatedly, multi-link device 300 can map the respective TID to a second access category queue of the 2.4 GHZ (i.e., secondary) link, wherein one or more contention window-related parameters (e.g., AIFS, CW, etc.) for the first access category queue define shorter time intervals than corresponding contention window-related parameters (e.g., AIFS, CW, etc.) for the second access category queue.

As depicted in FIG. 3, examples of the presently disclosed technology can create and configure specialized access categories-termed “extension” (i.e., Ext) access categories—in order to improve/optimize the above-described asymmetric TID-to-access category queue mapping.

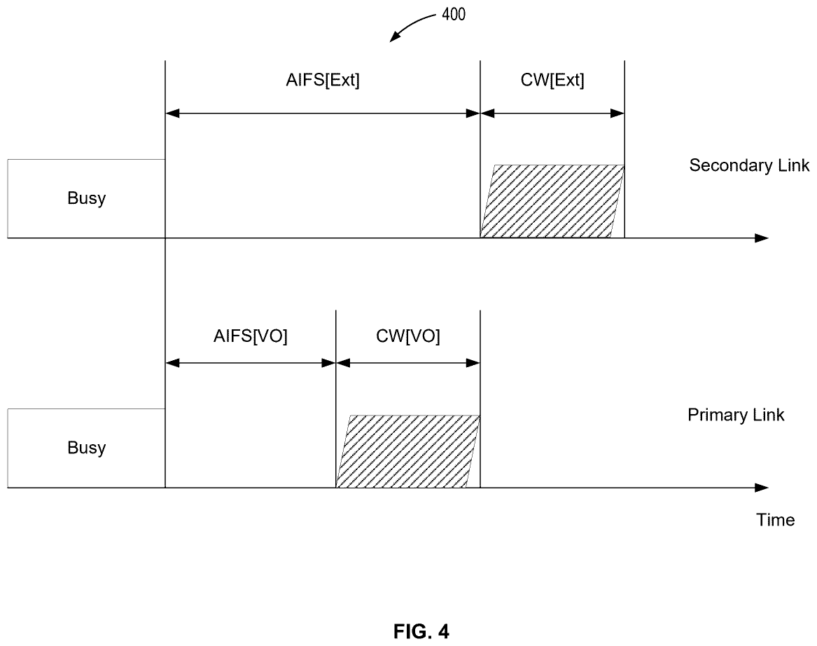

For example, multi-link device 300 may utilize an extension/Ext access category queue for the 5 GHz link and the 2.4 GHz link. As depicted in FIG. 4, the extension/Ext access category queue may define an AIFS [Ext] time interval to be greater than or equal to the sum of time intervals for AIFS [VO] and CW [VO] for the Voice/VO access category queue. Accordingly, under normal channel conditions (e.g., when both links/channels are free), the channel accessing time for the extension/Ext access category queue (i.e., AIFS [Ext]+CW [Ext]) will be longer than the channel accessing time for the Voice/VO access category queue (i.e., AIFS [VO]+CW [VO]).

Accordingly (and as depicted), multi-link device 300 can map a TID of 7 to a Voice/VO access category queue of the 5 GHZ (i.e., primary) link. Relatedly, multi-link device 300 can map the TID of 7 to the extension/Ext category queue of the 2.4 GHz (i.e., secondary) link. As described above (and as depicted in FIG. 4), the Voice/VO access category defines a shorter time interval for AIFS than the extension/Ext access category. Thus, under normal channel conditions, the 5 GHZ (i.e., primary) link will be more likely to win contentions for the TID of 7 than the 2.4 GHZ (i.e., secondary) link due to this shorter contention window-related time interval. In other words, multi-link device 300 can effectively “stack the deck” in favor of the 5 GHZ (i.e., primary) link winning contentions over the 2.4 GHZ (i.e., secondary link) through this asymmetric TID-to-access category queue mapping. While not depicted, multi-link device 300 can map other TIDs in the same/similar manner as the TID of 7.

FIG. 4 depicts an example diagram 400 illustrating contention window-related parameters for a primary link and a secondary link, in accordance with various examples of the presently disclosed technology.

As depicted (and as described above), contention window-related parameters (i.e., AIFS and CW) for the primary link may be associated with the Voice/VO access category. By contrast, contention window-related parameters (i.e., AIFS and CW) for the secondary link may be associated with an extension/Ext access category.

As depicted in FIG. 4, the extension/Ext access category queue may define an AIFS [Ext] time interval to be greater than or equal to the sum of time intervals for AIFS [VO] and CW [VO] for the Voice/VO access category queue. Accordingly, under normal channel conditions (e.g., when both links/channels are free), the channel accessing time for the extension/Ext access category queue (i.e., AIFS [Ext]+CW [Ext]) will be longer than the channel accessing time for the Voice/VO access category queue (i.e., AIFS [VO]+CW [VO]).

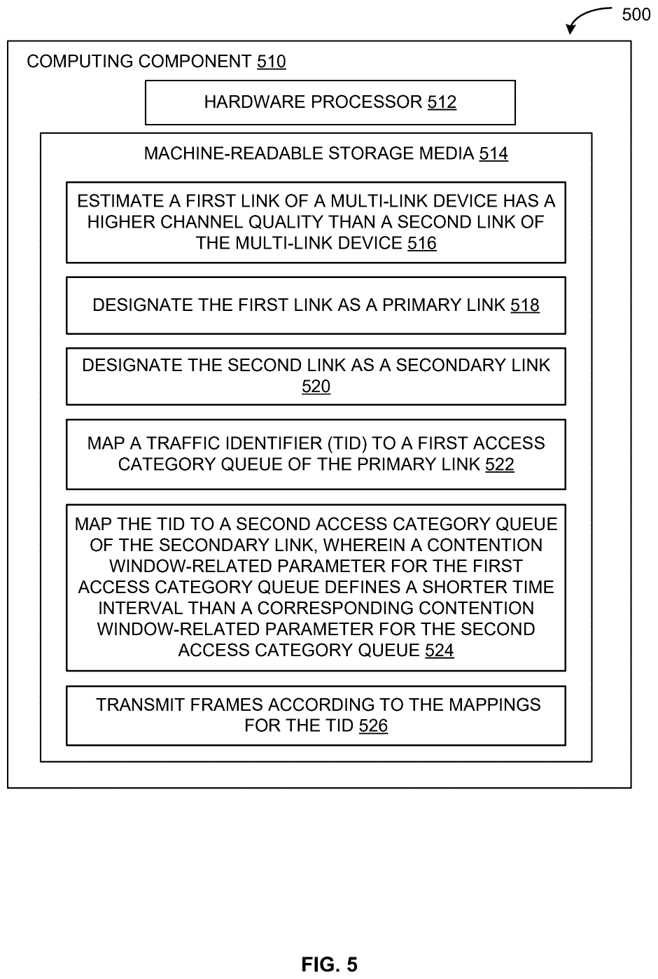

FIG. 5 depicts a computing system 500 that adjusts link priority for a multi-link device, in accordance with various examples of the presently disclosed technology. In various implementations, computing system 500 may comprise the multi-link device, although this need not be the case.

Referring now to FIG. 5, computing system 500 may comprise a computing component 510. Computing component 510 may be, for example, a server computer, a controller, or any other similar computing component capable of processing data. In the example implementation of FIG. 5, the computing component 510 includes a hardware processor 512, and machine-readable storage medium for 514.

Hardware processor 512 may be one or more central processing units (CPUs), semiconductor-based microprocessors, and/or other hardware devices suitable for retrieval and execution of instructions stored in machine-readable storage medium 514. Hardware processor 512 may fetch, decode, and execute instructions, such as instructions 516-522, to control processes or operations for burst preloading for available bandwidth estimation. As an alternative or in addition to retrieving and executing instructions, hardware processor 512 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 514, may be any electronic, magnetic, optical, or other physical storage device that contains or stores executable instructions. Thus, machine-readable storage medium 514 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 514 may be a non-transitory storage medium, where the term “non-transitory” does not encompass transitory propagating indicators. As described in detail below, machine-readable storage medium 514 may be encoded with executable instructions, for example, instructions 516-526. Further, although the instructions shown in FIG. 5 are in an order, the shown order is not the only order in which the instructions may be executed. Any instruction may be performed in any order, at any time, may be performed repeatedly, and/or may be performed by any suitable device or devices.

As depicted, hardware processor 512 can execute instruction 516 to cause computing system 500 to estimate a first link of the multi-link device has a higher channel quality than a second link of the multi-link device. The first link may be associated with a first frequency band (e.g., 5 GHZ) and the second link may be associated with a second frequency band (e.g., 2.4 GHZ).

Hardware processor 512/computing system 500 can use various techniques to make the estimation of instruction 516, such as techniques that analyze channel width, channel busy level, physical rate, interference level, etc. For example, Hardware processor 512/computing system 500 can estimate link quality using the following equation:

$$LINK\_QUAL = {CHAN\_BW}^{*} {( 1 - CHANNEL\_UTILIZATION )}^{*} 100 {\%}^{*} {PHY\_RATE}^{*} ( 1 - RETRY\_RATIO )$$

Here, “LINK_QUAL” may represent link quality for a respective link. “CHAN_BW” may represent channel bandwidth for the respective link. “CHANNEL_UTILIZATION” may represent channel utilization for the respective link. “PHY_RATE” may represent physical rate for the respective link. “RETRY_RATIO” may represent retry ratio for the respective link.

Hardware processor 512 can execute instruction 518 to cause computing system 500 to designate the first link as a primary link for the multi-link device. Similarly, hardware processor 512 can execute instruction 520 to cause computing system 500 to designate the second link as a secondary link for the multi-link device. In various implementations, if hardware processor 512 estimates that the first link has a higher channel quality than additional links of the multi-link device (e.g., a third link associated with a third frequency band), hardware processor 512 can execute instructions to cause computing system 500 to designate the additional (lower channel quality) links as secondary links as well.

Hardware processor 512 can execute instruction 522 to cause computing system 500 to map a traffic identifier (TID) to a first access category queue of the primary link. Similarly, hardware processor 512 can execute instruction 524 to cause computing system 500 to map the TID to a second access category queue of the secondary link, wherein a contention window-related parameter (e.g., AIFS) for the first access category queue defines a shorter time interval than a corresponding contention window-related parameter (e.g., AIFS) for the second access category queue. Accordingly, hardware processor 512 can execute instruction 526 to cause computing system 500 to transmit frames according to the mappings for the TID.

In various implementations, the first access category queue may comprise a queue associated with a first Enhanced Distributed Channel Access (EDCA) access category (e.g., Voice/VO). Similarly, the second access category queue may comprise a queue associated with a second EDCA access category (e.g., Video/VI). Here, the first EDCA access category may define shorter time intervals for one or more contention window-related parameters—e.g., AIFS, CW, etc. —than the second EDCA access category.

As alluded to above, through the above-described asymmetric TID-to-access category queue mapping, computing system 500 can ensure that frame traffic is more likely to be transmitted over the primary (i.e., higher performing) link during normal channel conditions, while still allowing frame traffic to be transmitted over the secondary link when the primary link is unavailable (e.g., due to high traffic load, interference, chip reset, scanning, etc.). Thus, under normal channel conditions, the primary link will be more likely to win contentions for the TID than the secondary link due to its shorter contention window-related time interval(s). In other words, computing system 500 can effectively “stack the deck” in favor of the primary link winning contentions over the secondary link through this asymmetric TID-to-access category queue mapping. Accordingly, during normal channel conditions most frame traffic will be transmitted over the primary link which has higher channel quality. However, if the primary link becomes temporarily unavailable (e.g., due to high traffic load, interference, chip reset, scanning, etc.), the secondary link may win contention for the TID despite its longer contention window time intervals, and frame traffic may be transmitted temporarily over the secondary link.

As alluded to above, computing system 500 can also dynamically adjust the above-described link priority in response to changing channel conditions.

For example, responsive to a change in channel conditions after designating the first link as the primary link and the second link as the secondary link, hardware processor 512 can execute additional instructions (not depicted) to cause computing system 500 to: (1) estimate the second link has higher channel quality than the first link; (2) redesignate the second link as the primary link; and (3) redesignate the first link as the secondary link.

While not directly depicted, hardware processor 512 can execute the same/similar instructions for additional TIDs (e.g., a second TID, a third TID, etc.).

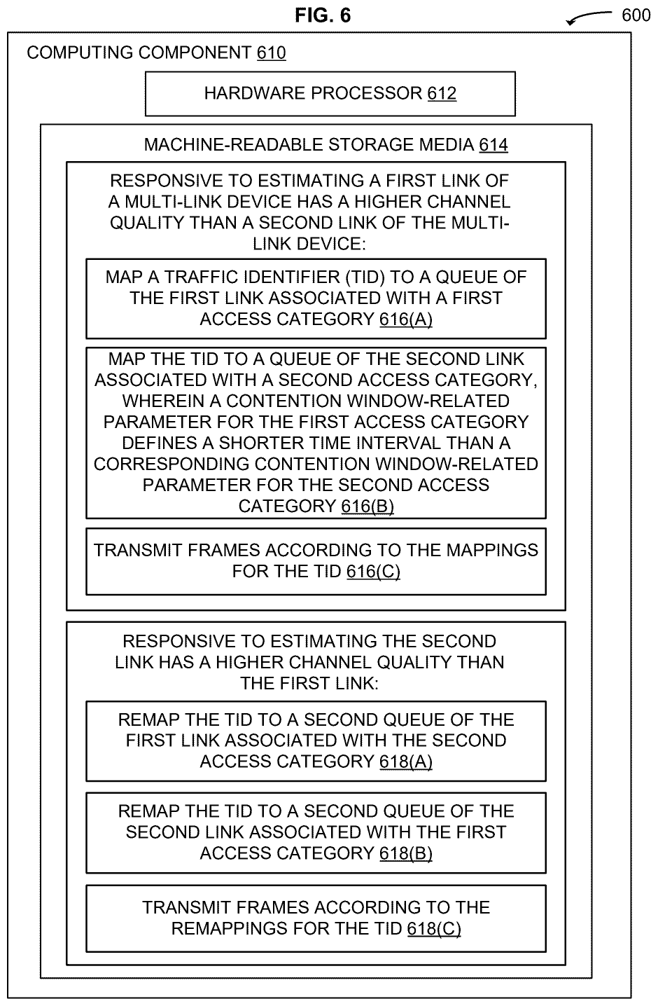

FIG. 6 depicts a computing system 600 that adjusts link priority for a multi-link device, in accordance with various examples of the presently disclosed technology. In various implementations, computing system 600 may comprise the multi-link device, although this need not be the case.

As depicted, computing system 600 comprises a computing component 610. Aside from its instructions, computing component 610 may be the same/similar as computing component 510 of computing system 500. Accordingly, common elements of computing component 510 will not be described again in the interests of brevity.

As depicted, responsive to estimating a first link of the multi-link device has a higher channel quality than a second link of the multi-link device, hardware processor 612 can execute instruction 616(A) to cause computing system 600 to map a traffic identifier (TID) to a queue of the first link associated with a first access category. Similarly, hardware processor 612 can execute instruction 616(B) to cause computing system 600 to map the TID to a queue of the second link associated with a second access category, wherein a contention window-related parameter (e.g., AIFS) for the first access category defines a shorter time interval than a corresponding contention window-related parameter (e.g., AIFS) for the second access category. Accordingly, hardware processor 612 can execute instruction 616(C) to transmit frames according to the mappings for the TID.

As described above, the first access category may comprise a first Enhanced Distributed Channel Access (EDCA) access category (e.g., Voice/VO). Similarly, the second access category may comprise a second EDCA access category (e.g., Video/VI). Here, the first EDCA access category may define shorter time intervals for one or more contention window-related parameters—e.g., AIFS and CW—than the second EDCA access category.

As depicted, responsive to estimating the second link has a higher channel quality than the first link (which itself may be responsive to a change in channel conditions), hardware processor 612 can execute instruction 618(A) to cause computing system 600 to remap the TID to a second queue of the first link associated with the second access category. Similarly, hardware processor 612 can execute instruction 618(B) to cause computing system 600 to remap the TID to a second queue of the second link associated with the first access category. Accordingly, hardware processor 612 can execute instruction 618(C) to transmit frames according to the remappings for the TID. In this way, computing system 600 can dynamically adjust the link priority in response to changing channel conditions.

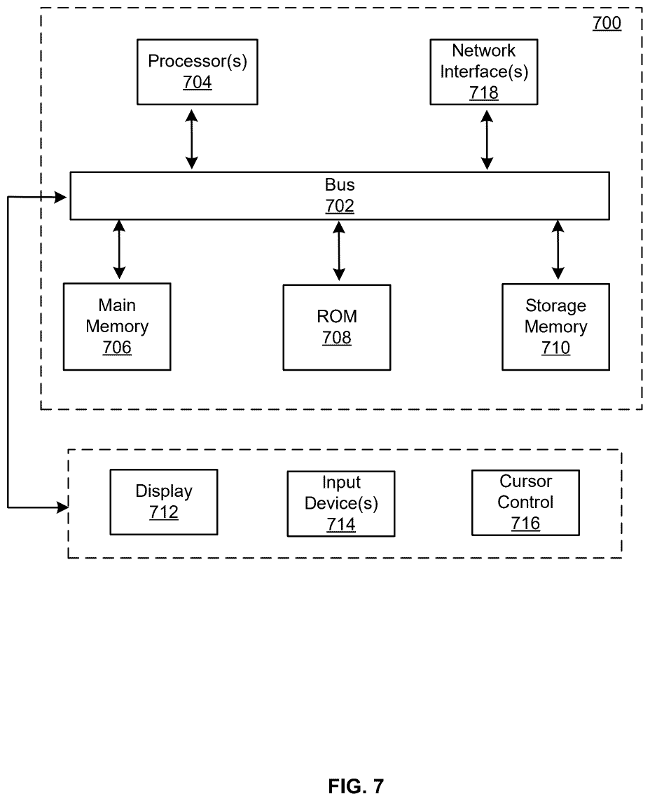

FIG. 7 depicts a block diagram of an example computer system 700 in which various of the examples described herein may be implemented. For example, multi-link device 200, multi-link device 300, computing system 500, and computing system 600 can be implemented using computer system 700. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical indicators that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical indicators that carry digital data streams. The indicators through the various networks and the indicators on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
responsive to estimating a first link of the multi-link device has a higher channel quality than a second link of the multi-link device:
mapping a traffic identifier (TID) to a queue of the first link associated with a first access category,
mapping the TID to a queue of the second link associated with a second access category, wherein a contention window-related parameter for the first access category defines a shorter time interval than a corresponding contention window-related parameter for the second access category; and
transmitting frames according to the mappings for the TID.

2. The method of claim 1, further comprising:
designating the first link as a primary link; and
designating the second link as a secondary link.

3. The method of claim 1, further comprising, responsive to a change in channel conditions after mapping the TID to the queue of the first link associated with the first access category and the queue of the second link associated with the second access category:
estimating the second link has higher channel quality than the first link;
remapping the TID to a second queue of the first link associated with the second access category; and
remapping the TID to a second queue of the second link associated with the first access category.

4. The method of claim 1, wherein:
the first access category comprises a first Enhanced Distributed Channel Access (EDCA) access category; and
the second access category comprises a second EDCA access category.

5. The method of claim 4, wherein:
the contention window-related parameter for the first access category comprises an EDCA parameter for the first EDCA access category; and
the corresponding contention window-related parameter for the second access category comprises a corresponding EDCA parameter for the second EDCA access category.

6. The method of claim 5, wherein:
the EDCA parameter for the first EDCA access category comprises a first arbitration inter-frame space (AIFS) parameter;
the corresponding EDCA parameter for the second EDCA access category comprises a second AIFS parameter; and
time interval for the first AIFS parameter is shorter than time interval for the second AIFS parameter.

7. The method of claim 1, further comprising:
mapping a second TID to a queue of the first link associated with a third access category;
mapping the second TID to a queue of the second link associated with a fourth access category, wherein a contention window-related parameter for the third access category defines a shorter time interval than a corresponding contention window-related parameter for the fourth access category; and
transmitting frames according to the mappings for the second TID.

8. A multi-link device comprising:
one or more processors; and
memory storing instructions, which when executed by the one or more processors, cause the multi-link device to:
responsive to estimating a first link of the multi-link device has a higher channel quality than a second link of the multi-link device:
map a traffic identifier (TID) to a queue of the first link associated with a first access category,
map the TID to a queue of the second link associated with a second access category, wherein a contention window-related parameter for the first access category defines a shorter time interval than a corresponding contention window-related parameter for the second access category, and
transmit frames according to the mappings for the TID.

9. The multi-link device of claim 8, wherein the memory stores further instructions, which when executed by the one or more processors, cause the multi-link device to:
responsive to estimating the second link of the multi-link device has a higher channel quality than the first link of the multi-link device:
remap the TID to a second queue of the first link associated with the second access category,
remap the TID to a second queue of the second link associated with the first access category, and
transmit frames according to the remappings for the TID.

10. The multi-link device of claim 8, wherein:
the first access category comprises a first Enhanced Distributed Channel Access (EDCA) access category; and
the second access category comprises a second EDCA access category.

11. The multi-link device of claim 10, wherein:
the contention window-related parameter for the first access category comprises an EDCA parameter for the first EDCA access category; and
the corresponding contention window-related parameter for the second access category comprises a corresponding EDCA parameter for the second EDCA access category.

12. The multi-link device of claim 11, wherein:
the EDCA parameter for the first EDCA access category comprises a first contention window (CW) parameter;
the corresponding EDCA parameter for the second EDCA access category comprises a second CW parameter; and
time interval for the first CW parameter is shorter than time interval for the second CW parameter.

13. The multi-link device of claim 8, wherein the memory stores further instructions, which when executed by the one or more processors, cause the multi-link device to:
responsive to estimating the first link of the multi-link device has a higher channel quality than the second link of the multi-link device:
map a second TID to a queue of the first link associated with a third access category,
map the TID to a queue of the second link associated with a fourth access category, wherein a contention window-related parameter for the third access category defines a shorter time interval than a corresponding contention window-related parameter for the fourth access category, and
transmit frames according to the mappings for the second TID.

14. Non-transitory computer-readable medium storing instructions, which when executed by one or more processing resources, cause a device to:
responsive to estimating a first link of the device has a higher channel quality than a second link of the device:
map a traffic identifier (TID) to a queue of the first link associated with a first access category,
map the TID to a queue of the second link associated with a second access category, wherein a contention window-related parameter for the first access category defines a shorter time interval than a corresponding contention window-related parameter for the second access category, and
transmit frames according to the mappings for the TID; and
responsive to estimating the second link has a higher channel quality than the first link:
remap the TID to a queue of the second link associated with the first access category,
remap the TID to a queue of the first link associated with the second access category, and
transmit frames according to the remappings for the TID.

15. The non-transitory computer-readable medium storing instructions of claim 14, wherein:
the first access category comprises a first Enhanced Distributed Channel Access (EDCA) access category; and
the second access category comprises a second EDCA access category.

16. The non-transitory computer-readable medium storing instructions of claim 15, wherein:
the contention window-related parameter for the first access category comprises an EDCA parameter for the first EDCA access category; and
the corresponding contention window-related parameter for the second access category comprises a corresponding EDCA parameter for the second EDCA access category.

17. The non-transitory computer-readable medium storing instructions of claim 16, wherein:
the EDCA parameter for the first EDCA access category comprises a first arbitration inter-frame space (AIFS) parameter;
the corresponding EDCA parameter for the second EDCA access category comprises a second AIFS parameter; and
time interval for the first AIFS parameter is shorter than time interval for the second AIFS parameter.

18. The non-transitory computer-readable medium storing instructions of claim 14, storing further instructions, which when executed by one or more processing resources, cause a device to:
responsive to estimating the first link of the device has a higher channel quality than the second link of the device:
map a second TID to a queue of the first link associated with a third access category,
map the second TID to a queue of the second link associated with a fourth access category, wherein a contention window-related parameter for the third access category defines a shorter time interval than a corresponding contention window-related parameter for the fourth access category, and
transmit frames according to the mappings for the second TID.

19. The non-transitory computer-readable medium storing instructions of claim 18, storing further instructions, which when executed by one or more processing resources, cause a device to:
responsive to estimating the second link has a higher channel quality than the first link:
remap the second TID to a queue of the second link associated with the third access category,
remap the TID to a queue of the first link associated with the fourth access category, and
transmit frames according to the remappings for the second TID.

20. The non-transitory computer-readable medium storing instructions of claim 14, storing further instructions, which when executed by one or more processing resources, cause a device to:
designating the first link as a primary link; and
designating the second link as a secondary link.
